(19) United States
(12) Patent Application Publication
(10) Pub. No.: US 2023/0214911 A1
(43) Pub. Date: Jul. 6, 2023

(54) SYSTEMS AND/OR METHODS FOR PRESENTING DYNAMIC CONTENT FOR SURVEILLED INDIVIDUALS

(71) Applicant: KNOT STANDARD LLC, New York, NY (US)

(72) Inventors: Matthew MUELLER, New York, NY (US); Julien RENOUARD, New York, NY (US); Adam NAMEJKO, New York, NY (US)

(21) Appl. No.: 17/928,841

(22) PCT Filed: May 28, 2021
(86) PCT No.: PCT/US2021/034732

§ 371 Date: Nov. 30, 2022

Related U.S. Application Data
(60) Provisional application No. 63/032,584, filed on May 30, 2020.

(51) Int. Cl. G06Q 30/0601; G06V 20/52

(52) U.S. Cl. CPC G06Q 30/0643; G06V 20/52; G06Q 30/0621

(57) ABSTRACT

Techniques are provided for controlling a digital display and surveillance system including display devices and at least one camera. Responsive to a determination that a person of interest has entered a location, one or more attributes of the person is/are recognized. A customized display is developed by an inference engine. The customized display provides an immersive experience with a level of customization detail based on the identified attribute(s) of the person. The display devices output the customized display. Surveillance information is provided to the inference engine based on surveillance of the person as the person moves about (and/or interacts with items) in the location. The surveillance uses data identifying a current area in the location that the person presently is in. Updates to the customized display are developed responsive to surveillance information being successively provided to the inference engine. The display devices are controlled to output the update.

### CROSS-REFERENCE TO RELATED APPLICATION

This application claims the benefit of U.S. Application Ser. No. 63/032,584 filed on May 30, 2020, the entire contents of which are hereby incorporated herein by reference.

### TECHNICAL FIELD

Certain example embodiments described herein relate to surveillance and custom display systems and/or methods. More particularly, certain example embodiments described herein relate to systems and/or methods for presenting interactive, dynamically-generated contextual content for individuals identified with differing levels of confidence as they are surveilled and as they interact with elements in a location.

### BACKGROUND AND SUMMARY

Custom clothing has been manufactured for years. Typically, a client will meet with a stylist (who might or might not also be a tailor). Such a meeting between a client and a stylist might take place in a showroom, at the client's home or office, or somewhere else. The stylist may take the client's measurements, suggest articles of clothing, materials, styling details, etc. To help the client visualize or even feel samples, the stylist may have on-hand for a meeting fabric samples, pictures of models wearing variously-styled garments, etc. In some cases, “off-the-rack” non-custom items might be physically available. Ultimately, an order will be placed and delivered to the client, with alterations possibly being performed after delivery.

This process for obtaining bespoke clothing has not changed dramatically over the years. Some innovations have been made around different ways of ordering and manufacturing clothing. And some innovations have been made in enabling stylists to travel to prospective clients. Yet not much else has changed. Particularly stagnant has been in-store or in-showroom experiences. Indeed, although the ability to customize articles of clothing has increased in terms of the amount and types of customizations possible, the ability to provide a customized shopping experience, especially in an in-store or in-showroom setting, has not.

It will be appreciated that it would be desirable to help address the above-identified and/or other problems. For example, it will be appreciated that it would be desirable to provide a more customized in-store or in-showroom experience for individuals purchasing articles of clothing or related items (regardless of whether such articles of clothing or related items are or are not bespoke).

One aspect of certain example embodiments relates to helping to address the above-described and/or other issues. For example, one aspect of certain example embodiments relates to systems and/or methods for providing a more customized in-store or in-showroom experience for individuals purchasing articles of clothing or related items (regardless of whether such articles of clothing or related items are or are not bespoke).

Another aspect of certain example embodiments relates to customizing experiences for potential clients automatically and programmatically recognized at different granularities. For example, a fine-grained recognition might recognize an individual potential client as being a particular individual with known purchases, styling selections, preferences, demographic information, etc. A coarser recognition might recognize an individual potential client based on discernable demographic data (such as, for example, approximate age or age range, race, ethnicity, gender, gender expression, etc.) and/or individual style (e.g., based on, for example, recognized shoes; clothing types, styles, and/or quality; etc.).

Still another aspect of certain example embodiments relates to generating, on-the-fly, a custom immersive multimedia display experience tailored for a potential client.

In certain example embodiments, there is provided a method of controlling a digital display system comprising a plurality of display devices provided in a location, a computing system having a data store and processing resources including at least one processor and a memory coupled thereto, and at least one camera in the location. Responsive to a determination that a person of interest has entered the location, one or more attributes of the person of interest is/are recognized. A customized display to be output for the display devices is developed. The customized display is developed by an inference engine running on the computing system in connection with the processing resources. The customized display provides an immersive experience with a level of customization detail based on the identified attribute(s) of the person of interest. The display devices are controlled to output the customized display. Surveillance information is provided to the inference engine based on the surveillance of the person of interest as the person of interest moves about (and/or interacts with items) in the location. The surveillance is practiced using data identifying a current area out of a plurality of predefined areas in the location that the person of interest presently is in. Updates to the customized display are developed responsive to surveillance information being successively provided to the inference engine. The display devices are controlled to output the update.

In addition to the features of the previous paragraph and the other methods described herein, counterpart systems, non-transitory computer readable storage media tangibly storing instructions for performing such methods, executable computer programs, and the like, are contemplated herein, as well.

These features, aspects, advantages, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a block diagram showing example components of a digital display and surveillance system, in accordance with certain example embodiments;

FIG. 2 is a schematic view showing example elements provided in an example location, in accordance with certain example embodiments;

FIG. 3 is a schematic view showing an example layout for a first display array, which may be used in connection with certain example embodiments;

FIG. 4 is a schematic view showing an example layout for a second display array, which may be used in connection with certain example embodiments;

FIGS. 5A-5B show example content provided to the FIG. 3 example display array, the example content having a type that may be provided in connection with certain example embodiments;

FIGS. 6A-6F show example content provided to the FIG. 4 example display array, the example content having a type that may be provided in connection with certain example embodiments;

FIG. 7 is a flowchart showing an example process for operating a digital display and surveillance system, in accordance with certain example embodiments; and

FIG. 8 is a flowchart showing an example process for operating a digital display and surveillance system when there are multiple potential clients in a location, in accordance with certain example embodiments.

### DETAILED DESCRIPTION

Certain example embodiments described herein relate to techniques for controlling a digital display system comprising a plurality of display devices provided in a location, a computing system having a data store and processing resources including at least one processor and a memory coupled thereto, and at least one camera in the location. Responsive to a determination that a person of interest has entered the location, one or more attributes of the person of interest is/are recognized. A customized display to be output for the display devices is developed. The customized display is developed by an inference engine running on the computing system in connection with the processing resources. The customized display provides an immersive experience with a level of customization detail based on the identified attribute(s) of the person of interest. The display devices are controlled to output the customized display. Surveillance information is provided to the inference engine based on the surveillance of the person of interest as the person of interest moves about in the location. The surveillance is practiced using data identifying a current area out of a plurality of predefined areas in the location that the person of interest presently is in. Updates to the customized display are developed responsive to surveillance information being successively provided to the inference engine. The display devices are controlled to output the update.

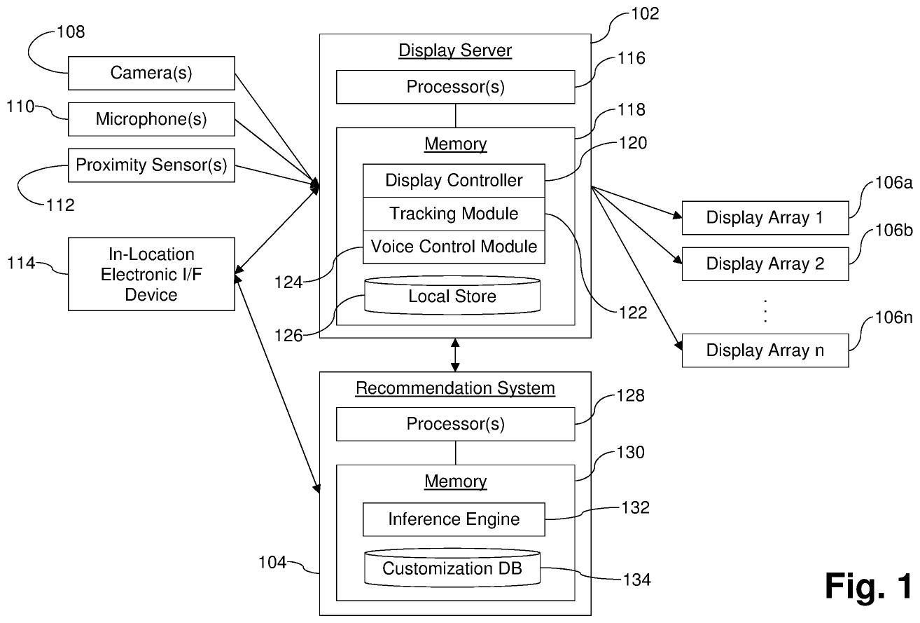

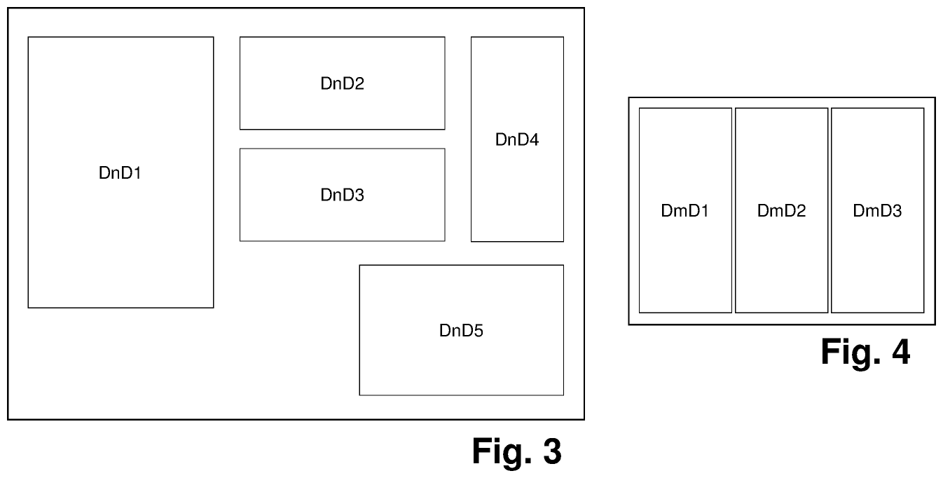

Referring now more particularly to the drawings, FIG. 1 is a block diagram showing example components of a digital display and surveillance system, in accordance with certain example embodiments. The FIG. 1 example display system includes a display server 102 and a recommendation system 104. The display server 102 is responsible for controlling one or more display arrays 106a-106n, which may be provided in a single location (e.g., a single showroom) or across multiple locations (e.g., multiple showrooms in close relative proximity to one another, multiple showrooms in disparate locations, etc.). Each display array may include one or more display devices (e.g., LCD televisions, professional displays, projectors, computer monitors, and/or the like). The display areas 106a-106n may have the same or different configurations, as will be appreciated from the description provided below in connection with FIGS. 3-4, for example. Communications between the display server 102 and the display arrays 106a-106n may be provided via any suitable wired or wireless connection (e.g., HDMI, display port, IP, or other wired connection; using a wireless protocol such as Miracast, Chromecast, etc.; by interfacing with an application on a smart television or a lightweight device connected to a display; etc.).

Input to the display server is provided by one or more cameras 108, one or more microphones 110, and one or more proximity sensors 112. An in-location electronic interface device 114 (e.g., a laptop, smartphone, tablet, or other device) may be used by an authorized individual in a location to interface with the display server 102 and/or the recommendation system 104. The in-location electronic interface device 114 may be used by a stylist working with a potential client, e.g., to make notes about interactions with physical products including likes/dislikes, to show images and/or videos of products that might not be physically present, to show different style models or styling options (e.g., different ensembles of articles), etc. The device 114 thus may include its own processing resources (e.g., at least one processor and a memory coupled thereto) that execute a standalone program or provide access to a web application facilitating interaction with the display server 102. It is noted that the device 114 may be used by the potential client in certain example instances, e.g., without the aid of a separate authorized individual (such as an authorized stylist, for example). These various input devices may communication with the display server 102 and/or the recommendation system 104 via any suitable connection such as, for example, a wired or wireless network connection making use of, for example, a LAN, WAN, the Internet, and/or the like. In certain example embodiments, the device 114 may be brought into the location by the potential client. For instance, the device 114 may be the potential client's personal smartphone, tablet, laptop, or other electronic device, and it may run an application or access a webpage that interfaces with the display server 102. In such cases, a proximity check may be made using location services of the device to help ensure that the correct display server 102 is being controlled and/or to help ensure that the correct display server 102 is not being used in an unauthorized and/or otherwise inappropriate manner (e.g., by a potential customer browsing from home or another store, etc.).

The display server 102 and the recommendation system 104 may be a part of the same or different computing platforms in different example embodiments. In certain example embodiments, a different display server may be provided for each location, whereas the recommendation system 104 may be more centralized such that it serves some or all of display servers provided by an enterprise. FIG. 1 implies how functionality may be shared between the display server 102 and the recommendation system 104. However, it will be appreciated that different example embodiments may share processing loads differently, even when separate computing platforms are provided for the display server 102 and the recommendation system 104. For example, at least some recommendation-related functionality may be performed locally to avoid time delays, at least some display-server related functionality may be performed remotely to help ensure consistent and accurate data reporting across multiple locations, etc.

The display server 102 includes a first set of processing resources, including at least one processor 116 and a memory 118 which is coupled to the processor(s) 116. The memory 118 may be any suitable combination of volatile and non-volatile storage provided locally or at a remote location. The memory 118 includes instructions that, when executed by the processor(s) 116, perform program functionality. This may be accomplished by, for example, executing software modules or the like. FIG. 1, for example, shows software modules including a display controller 120, tracking module 122 (useful for tracking a person's movements in a physical location and distinguishing between different people when there are multiple potential clients in a given location, for example), and voice control module 124. The display controller 120 interfaces with the display arrays 106a-106n, as well as the recommendation system 104. With regard to the latter, for example, the display controller 120 may marshal input from the camera(s) 108, microphone(s) 110, proximity sensor(s) 112, and/or in-location electronic interface device 114, and send it to the recommendation system 104 to obtain a recommendation of articles to be displayed based on this and/or other information (e.g., as described in greater detail below).

The display controller 120 also may consult a series of rules stored in the local store 126 (for example) explaining what is to be displayed, and how it is to be displayed, based on (for example) these and/or other inputs. These rules may specify, on a display array type basis, information layouts (e.g., where certain information is to be provided), what type of information is to be provided (e.g., combinations of videos showing complete wardrobe ensembles on a moving model, styling options, close-ups of optional accessories or customization details, etc.), when the displays should be changed (e.g., based on a client interaction with a physical article in the store, input from the device 114 from an authorized stylist, movement to another area of the store, etc.), and so on. The received input may be matched to the closest applicable rule, or rules may be defined and applied in a predefined order such that it is clear which display rule(s) is/are to apply. The information to be displayed based on the applicable rule may be set based on program logic embedded in or otherwise linked to by the applicable rule. That is, program logic may define the above-described and/or other facets of the display, using a combination of fixed and variable contents. Fixed content may include stock layouts and/or imagery, and variable contents may be more dynamic based on changing data. Thus, the program logic may be parameterized to receive input from the inference engine 132 and/or other inputs from the location, for example. The local store 126 may buffer information sent to the display server 102 from the various input devices and/or the recommendation system 104, data to be distributed to the various display arrays, etc.

Similar to the display server 102, the recommendation system 104 may include its own processing resources (e.g., processor(s) 128 and memory 130), with the memory facilitating execution of an inference engine 132 that makes recommendations about clothing based on information stored in a customization database 134 stored local to the recommendation system 104 or remote therefrom. The inference engine 132 may, for example, suggest garments that a potential user might be interested in based on prior selections or purchases, stated preferences, inferred preferences based on interactions monitored at the location as provided to it via the device 114 and/or the display server 102, pre-programmed rules about how items should be styled (e.g., do not match black belts with brown shoes, only offer styling options relevant to a garment so that, for example, functional buttons are offered for at least certain blazers but not eyeglasses), pre-programmed rules regarding suggested pairings (e.g., linking brown shoes with coordinating belts for navy suits, differently colored slacks for a blazer or sport coat fabric being examined “live” and in the store, etc.), and/or the like.

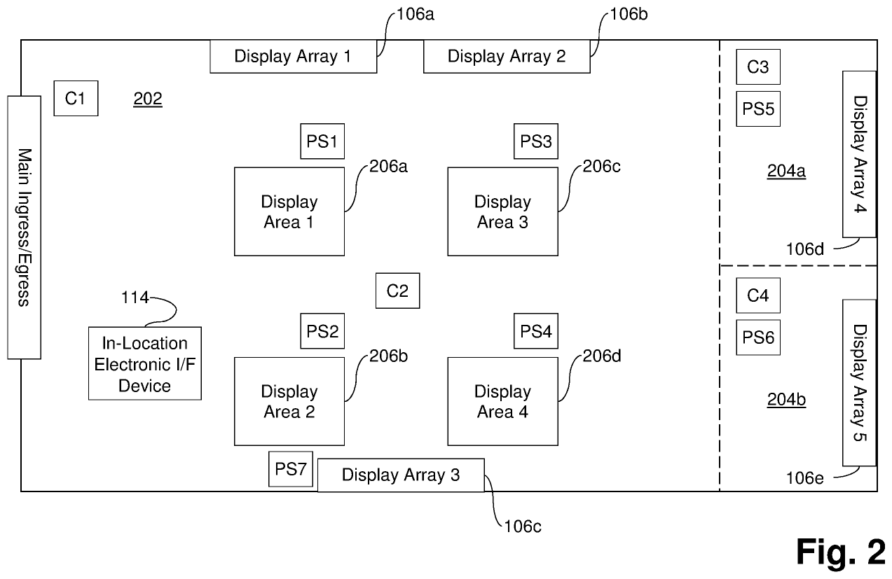

FIG. 2 is a schematic view showing example elements provided in an example location, in accordance with certain example embodiments. The FIG. 2 example location includes a hypothetical store setup, where there is a main showroom 202 and private meeting areas 204a-204b. It will be appreciated that these and other aspects described in connection with FIG. 2 are provided by way of example and without limitation. For instance, it will be appreciated that the discussion of the number of private meeting areas, number and types of display areas, number and types of display arrays, camera locations, etc., are provided by way of example and without limitation. As another example, more than one showroom may be provided on more than one floor.

Referring specifically to the FIG. 2 example, the main showroom 202 includes a camera C1 proximate to the main point of ingress and egress. The camera C1 may be used to detect when a potential client (whether new or returning) has entered into the FIG. 2 location. Four different display areas 206a-206d are provided in the FIG. 2 example location. These display areas may include display racks, shelves, tables, or other merchandisers, arranged in any suitable orientation. In the FIG. 2 example, a second camera C2 is able to surveil all of the display areas 206a-206d, although it will be appreciated that more cameras may be used in different setups (e.g., one camera may be associated with each display area, one camera may be associated with 2 or more display areas, multiple cameras may have overlapping fields of vision which may correspond to one or more display areas each, etc.). In the FIG. 2 example, separate proximity sensors PS1-PS4 are provided for each of the display areas 206a-206d. In the FIG. 2 example, the in-location electronic interface device 114 may be a mobile device that is movable around in the confines of the location. In certain example embodiments, multiple different devices may be provided, e.g., to accommodate different stylists and/or different clients in the store at the same time. In certain example embodiments, the device 114 may be usable only by authorized personnel in the location. Indifferent example embodiments, the device 114 may be usable by authorized personnel and/or potential customers. In certain example embodiments, although not shown in FIG. 2, a potential customer may use a personal electronic device such as, for example, a smartphone, tablet, laptop, or the like, to perform the same or similar functionality as that offered by the device 114.

Each of the meeting rooms 204a-204b in the FIG. 2 example embodiment has its own display array, camera, and proximity sensor. In the first meeting room 204a, camera C3 and proximity sensor PS5 are provided along with display array 106d. In the second meeting room 204b, camera C4 and proximity sensor PS6 are provided along with display array 106e.

Proximity sensors and/or cameras may be provided in connection with display arrays in certain example embodiments. For example, display array 106c has an associated proximity sensor PS7. This may be useful to determine when an image has attracted the interest of a potential client, when a display is touch- or otherwise interactive, etc. Information about the client's attention being caught can, for example, be a clue fed to the inference engine 132 of the recommendation system 104, signifying that the potential client is interested in something being shown on the display. For instance, if the potential client is determined to be looking at a particular advertisement or stock media, aspects thereof that are knowable based on what is being displayed and which may in some instances be retrieved as a lookup of annotation data added to or otherwise associated with the content (e.g., garment type, styling information, etc.) may be fed to the inference engine, potential with sentiment analysis information (e.g., reflecting inferences about emotional state). In this way, if a potential client has a strong positive or negative reaction towards something being shown (e.g., the potential client seems to really or dislike a summer ensemble), the output from the inference engine can be influenced accordingly (e.g., to show similar or dissimilar options, coordinating or contrasting options, etc.). Styling aspects thereof can also be received and reused (e.g., if the potential client seems to really or dislike shawl vs. notch collars on a tuxedo, etc.).

In certain example embodiments, separate cameras and proximity sensors need not be used. For instance, in certain example embodiments, the cameras may serve as proximity sensors themselves. In certain example embodiments, location services from the device 114 and/or a personal device of the potential client may be used as proximity sensors.

The display arrays 106a-106e shown in the FIG. 2 example may be the same or different in different example implementations. In one form, adjacent display arrays (such as display arrays 106a-106b) may be the same. In one form, display arrays provided to private meeting rooms (such as display arrays 106d-106e) may be the same so as to promote uniformity or consistency in feel between the different meeting rooms. As alluded to above, some displays may be touch-interactive (such as display array 106c) or the like.

FIG. 3 is a schematic view showing an example layout for a first display array, which may be used in connection with certain example embodiments, and FIG. 4 is a schematic view showing an example layout for a second display array, which may be used in connection with certain example embodiments. In the FIG. 3 and FIG. 4 example display arrays, a common naming convention is used. The naming convention includes a first “D” (for display array) followed by a letter providing an identifier for the particular display array, and a second “D” (for display device) followed by a number providing an identifier for the particular display device in the associated array. In FIG. 3, differently sized and arranged display devices are provided in connection with the display array designated “n”. Because there are five different display devices, the display devices are labeled DnD1, DnD2, DnD3, DnD4, and DnD5. In a similar manner, FIG. 4 includes three commonly sized and oriented display devices provided in connection with the display array designated “m”. Because there are three different display devices, the display devices are labeled DmD1, DmD2, and DmD3. This or another naming convention may be used to address the display devices in the individual displays. That is, content that is generated may be tagged with an indicator specifying the display array and display device to which it is to be output. The naming convention may further include a location, e.g., when a single display server is associated with multiple different brick-and-mortar locations. Of course, different embodiments may use different display array configurations, with such display array configurations including at least one (and potentially more than one) display.

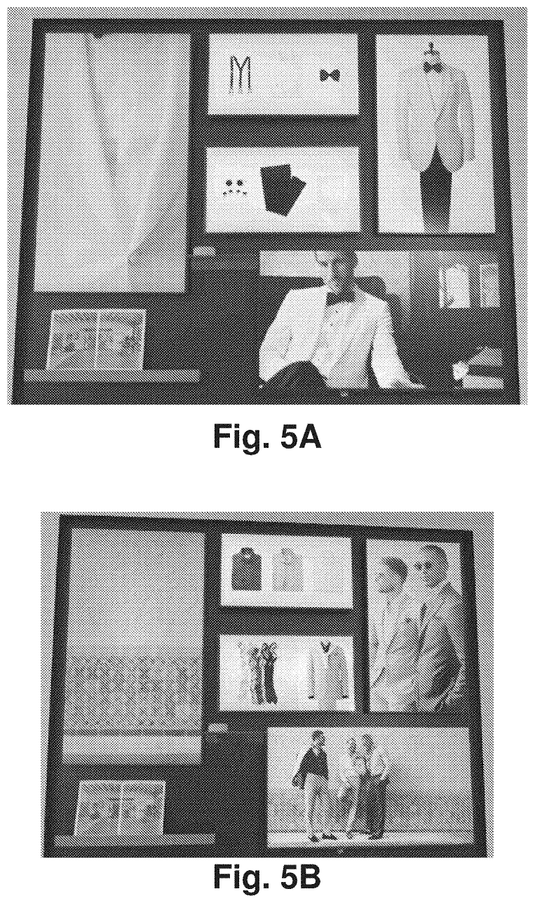

FIGS. 5A-5B show example content provided to the FIG. 3 example display array, the example content having a type that may be provided in connection with certain example embodiments. Overall, the FIG. 5A display array includes dynamic content related to a tuxedo. Of course, it will be appreciated that the dynamic content may relate to different garments and/or garment collections (e.g., such as, for example, those described in greater detail below). The DnD1 display device provides a video of a model in motion, showing how the tuxedo appears in movement. Subjectively, potential clients may find this moving image to be attractive. Moreover, human eyes oftentimes are drawn to an upper-right or right-side image. Therefore, having an “attract loop” or other “attract imagery” that is fixed or dynamic in this display area (which also is designed to be larger) may be beneficial for engaging with potential clients. The DnD2 and DnD3 display devices include accessories including formal braces, a shirt, bowtie, cufflinks, pants, and a pocket square. The DnD4 display device provides a view of the ensemble on a manikin, and the DnD5 display device provides a view of the ensemble on a seated, still human model. Thus, the smaller display screens provide content that supplements the attract loop content, adding additional potentially bespoke details that do not detract from the larger main attract content.

Voice controls may be used to control the display array. For example, a voice command could be used to cause the white jacket to change to a black jacket, change the jacket's lapel to a shawl collar, change the color of the tuxedo to a different color and/or material, etc. Voice-activated control may be provided by a stylist and/or potential client in different example embodiments. In certain example embodiments, voice-activated control may be limited to stylists, e.g., whose voices are used to train the display server 102 such that the display controller 120 only responds to authorized stylists.

Voice-activated control, whether performed by a stylist or a potential client, can be used to further personalize the showroom, e.g., to show the product and outfits in which the potential client is interested. For example, a potential client who is recognized when entering into the physical location may be assumed to be interested in a tuxedo because the customization database 134 stores information indicating that a tuxedo was last discussed with a stylist, a current tuxedo was ordered a certain amount of time in the past (e.g., and therefore is deemed to be “due” for replacement by the inference engine based on preprogramed rules or the like), a pre-visit survey or inquiry indicated that the potential client arriving for the visit was in the market for a new tuxedo, etc. However, through voice and/or other control, the display array may be controlled to show different (e.g., casual) clothing or items. As a result, the FIG. 5B images may be provided.

The FIG. 5B images show a variety of casual images, which may be curated on-the-fly or in advance to match with garments already owned by the potential client, or garments in which the potential client has expressed interested (e.g., via in-store interactions, etc.). Different shirts, suits (with different levels of formality), ties, shoes, and/or the like may be provided.

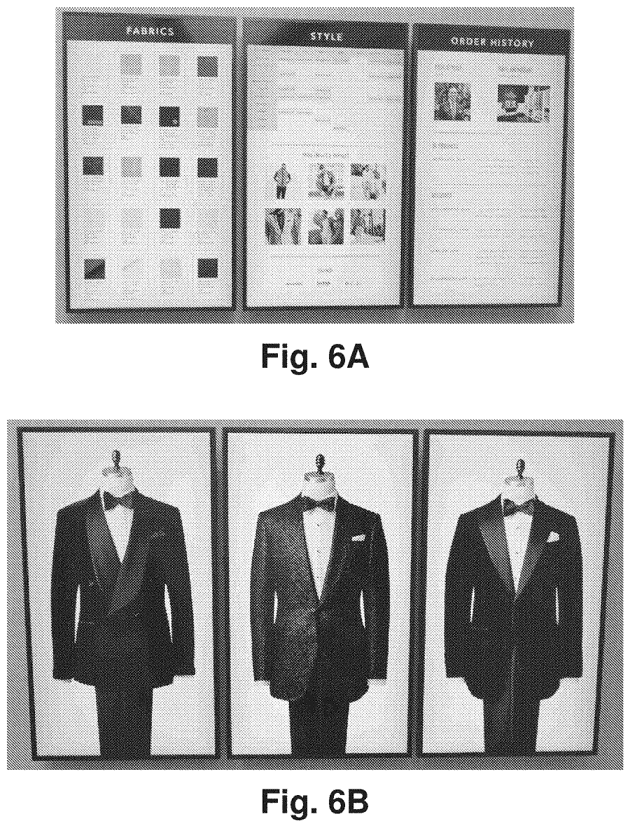

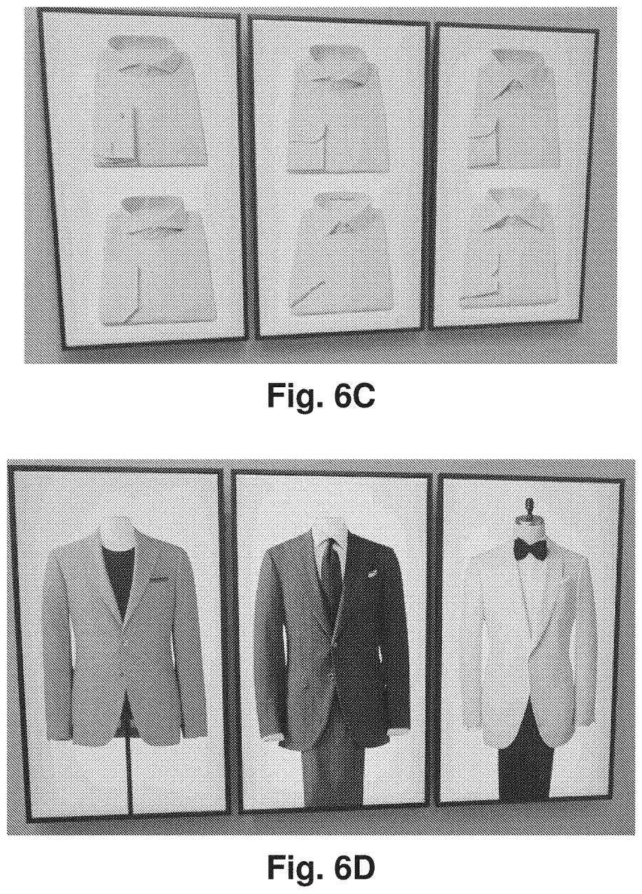

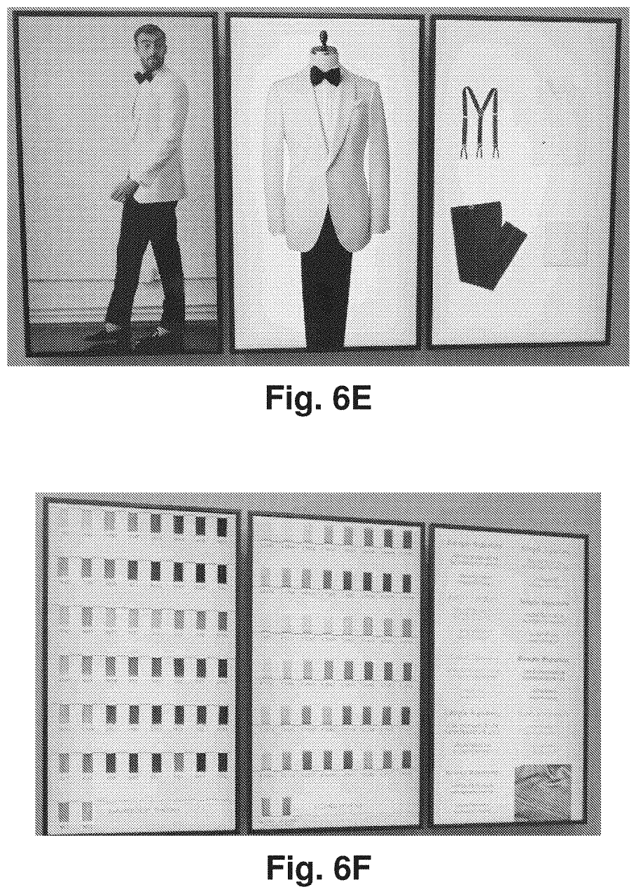

FIGS. 6A-6F show example content provided to the FIG. 4 example display array, the example content having a type that may be provided in connection with certain example embodiments. FIG. 6A shows a client's sartorial “DNA,” which here includes information regarding fabrics that have been purchased, styling and styling preference information, order history information, etc. In the leftmost display device in FIG. 6A (corresponding to DmD1 in FIG. 4), the fabrics information includes swatches for each owned article of clothing. Associated with the swatches is information about the individual items. For instance, order date, short product description, factory code, identifier embedding customization information in the case of custom clothing, etc., is shown. At least some of the FIG. 6A information is shown in and described in connection with U.S. Publication No. 2020/0394699, the entire contents of which are hereby incorporated herein by reference.

In the center display device in FIG. 6A (corresponding to DmD2 in FIG. 4), at the top, styling information for articles purchased, or otherwise being indicated as being preferred, by the potential client are shown. This styling information is retrieved from the customization database 134. It includes a grid, with the vertical axis listing “staple” articles of clothing and the horizontal axis listing basic “staple” colors or patterns. The individual cells in the table here indicate whether the user already owns the article of clothing (“KS” here stands for Knot Standard, the assignee of the instant application), and whether the user has expressed a preference as to wanting or not wanting a particular item. It will be appreciated that at least some of this information (including the already purchased indicators) may be available for both custom and non-custom scenarios. Even in non-custom scenarios, algorithms may infer that an item likely is wanted or not wanted based on product returns, relative dwell time on product pages in browser windows, repeat visits to product pages, search history, in-store interactions, inferred emotional states while interacting with articles in the store, and/or the like.

In the custom design scenario, basic design information may define basic staples of clothing such as, for example, those provided on the vertical axis of the table in FIG. 3. Customizations may be defined as a series of layers added onto the basic design for the default garment type. For example, there is a wide variety of customizations applicable to sport jackets including, for example, lapel type, vent types, lining type, whether stitching is present, whether buttons on sleeves are functional, whether ticket pockets are included, how many interior pockets are provided and whether they are located, etc. These customizations are, of course, exclusive of colors, patterns, fabric types, and much more. The use of layers simplifies styling selections by operating at different levels of granularities. These layers for styling at different granularities may include, for example, layers for the time of year (e.g., implying summer-weight suits, flannel suits, three-season suits, etc.), fabric, construction (e.g., presence and/or amount of padding, etc.), styling, whether worn (e.g., work, casual, or other purposes), geographical location (e.g., the city in which the person resides), durability, visual patterning (e.g., for matching with other articles in accordance with a major/minor/major or other common patterning regime, etc.), how it fits in or complements the existing wardrobe, and so on. Yet another layer may indicate, for example, how “expressive” the person and/or stylist is/are with clothing choices, reflecting comfort in decision-making and styling decisions, etc. This information may be stored in the database and used to power recommendation engines, as noted in greater detail below.

Below the grid is a series of images showing styles that the user has expressly or impliedly shown interest in, e.g., via a direct statement to a stylist, completion of a survey, clicking on an email link, and/or the like. These images show outfit collections and thus are helpful to provide an overall sense of style. The brand logos provided below the images convey similar information and may be gathered in the same or similar ways. Additional information about fit may be intuited from this information. For example, some tailors solicit feedback about fit by asking for information about how a suit feels, while others are comfortable sharing such information in-person or via surveys. Information indicating whether a more tailored fit might be reflected in images showing more tapered legs and higher in-seems on pants. Other information such as armholes being too tight may be recorded in the database but not readily shown. Thus, some fit-related and/or other information may be visualized in exemplary garments, but visualizations are not required. The data nonetheless may be recorded in the customization database 134.

In the rightmost display device in FIG. 6A (corresponding to DmD3 in FIG. 4), historical order information for the client is shown, with this order information having been retrieved from the customization database 134 as above. For example, this display device includes a picture and link to a personal stylist, along with a picture and link to a local showroom. This showroom information may be based on the current location of the client. The order information below that may show information about articles of clothing already ordered and/or purchased. Here, the information includes an order/purchase date, a short description of the article, and the date delivered. Selecting an item (via voice command, touch, or the like) may provide product information related to the particular selection.

It is noted that the customization database 134 may be structured as a relational database, object-oriented database, and/or the like. XML, JSON, and/or other like technologies may be used for structuring all or parts of the backend database, e.g., facilitating the easy tagging of articles to enable the example functionality described herein. Based on the information provided above, it will be appreciated that the backend database can be used to provide information about the product, material, basic design of the garment, specific customization decisions for the garment in the custom clothing scenario, a link to care instructions, client history, and/or the like. Thus, certain example embodiments “know” specifics about the article of clothing and potentially also specifics about the person who owns it. Some or all of the garment- and/or user-specific information can be used to generate dynamic displays with the information typically provided on tags or labels, supplemented by much more information—even in non-custom mass production scenarios.

Returning to the tuxedo example, FIG. 6B shows differently styled tuxedos. Presenting variations next to one another may enable the potential client to understand nuances that might otherwise be noticed. For example, although differences in double breasted blazers and single button blazers may be easily understood, differences in how that might affect a shawl collar might not be as easy to visualize or compare. Similarly, fine stylistic differences, such as the difference between a black and a white pocket square, may be more readily appreciated if the images are shown side-by-side. The images selected may be pre-curated by a stylist, automatically generated by the recommendation system 104 based on stated user preferences and/or interactions with materials in a showroom, etc. Because the client is in an actual showroom, “real” samples may be provided for the client to interact with and, e.g., so that different aspects of the garment being selected or customized can be interacted with.

In a related vein, with reference to FIG. 6C, a client can easily see the difference between different collar and cuff types. A client similar can see what different combinations would look like. These images may be pre-curated for initial presentation. They may be manipulated (e.g., to change different collars and/or cuffs in different enumerated display devices or display device areas based on voice, touch, or other input), etc.

Different clothing ensembles are presented in FIG. 6D, e.g., based on the client's intuited preferences. The display in FIG. 6D starts with the most casual option at the left and gets more formal moving to the right (although other arrangements certainly are possible). It can be inferred from these images that the prospective client enjoys blues, and mixing textured or lightly patterned blues with dark solids. It also can be intuited that the client likes pocket squares. These details are evident in FIG. 6D display array.

Should a client seek more information about a given image (e.g., the ensemble shown in the far right display in FIG. 6D), a display presentation such as that presented in FIG. 6E may be provided. This display presentation is similar to that discussed above in connection with FIG. 5A, in that it includes a moving image of the ensemble on a model, a manikin with the ensemble on it, and details concerning accessories or other items that comprise the ensemble which may not be visible or as easily visible (e.g., the braces), or which could be substituted (e.g., the shirt with visible studs at the right rather than covered buttons in the center).

FIG. 6F shows how the client can be empowered to make a wide variety of customization decisions including, for example, stitch colors, monogram fonts, etc.

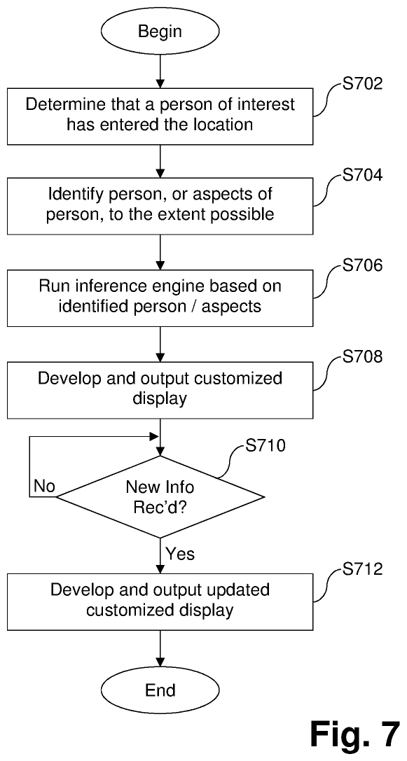

FIG. 7 is a flowchart showing an example process for operating a digital display and surveillance system, in accordance with certain example embodiments. In step S702, a determination is made that a person of interest has entered the location. Persons of interest include potential clients and not, for example, people who may be recognized as stylists or other employees who work at the location, recognized couriers, etc. The recognition may be performed by a proximity sensor and/or camera that has visibility to an entrance to the location. In step S704, an attempt is made to identify the person, or at least aspects of the person, to the extent possible. In some instances, this may be facilitated if a person books an appointment and arrives as a location. Then, data from the camera can be cross-referenced with known images of the person (e.g., provided by the person, gleaned from a social media site such as Facebook, Instagram, Twitter, or the like, etc.) in order to confirm that the person is arriving. This kind of cross-referencing can be used to greatly reduce the search space for facial recognition (which may be performed using known computer-implemented techniques). Facial recognition may be run across social media platforms using application programming interface (API) calls, accessing web services exposed by such social media platforms, etc. As another example, a stylist or other employee who recognizes a person entering into a store may provide an indication of the person's name using a mobile device or the like. As still another example, a person may scan a QR code or other code sewn into or otherwise attached to a garment that can be used to access the customization database 132 to identify a unique garment and, as a result, a person who purchased that unique garment. If the person is recognized, the person may have a user profile stored in the customization database 132. The user profile may include information concerning garments and garment-related preferences of the pre-registered user, e.g., the DNA discussed above. This user profile information may be taken into account by the inference function, which functions as noted below.

If a person cannot be identified as a particular individual (who may or may not have a set of preferences), the system may attempt to identify aspects or attributes of the person. This may include using data from the camera to apply known computer algorithmic approaches to infer demographic information about the person. This demographic information may include, for example, the person's age or age range, race, ethnicity, gender, gender expression, etc. Similar techniques may be used to attempt to place particular types of clothing (e.g., shoe brand) or other items (type of watch or sunglasses). Having such information available can be useful, as patterns develop between people who dress in certain ways. As a course filter, different styles tend to be popular for different age ranges, and recognizing designer sunglasses or luxury watches can provide valuable information about presumed budget, material preferences, etc. The ways that persons style their own clothing can also be informative (e.g., persons who walk in with untucked shirts may prefer finished bottom and shorter button-down shirts compared to those who wear their shirts tucked in, when coming into the location). Another attribute that can be sense is whether the person is carrying or wearing accessories. Luxury brand purses or the like can inform the system of the user's tastes. If the person is not wearing a mask but one is required for entry into the location, the system can sense this and update the displays to show a reminder or a series of progressive screens reminding the person to put on a mask.

Once this information has been gathered, in step S706, the inference engine is run using the identified person of interest and/or the identified aspects of the person of interest. A customized display is developed and provided to the display arrays in the location in step S708. The displays generated may be based on the output based on the results of the inference engine in certain example embodiments. For instance, for a recognized person of interest, the inference engine may determine that the person previously was interested in tuxedos, has certain staple suits that are going out of fashion or are old, etc. In such cases, the display array(s) may provide an immersive experience for the person of interest, which suggests items the person is likely to want to see and possibly purchase. In other cases, the inference engine may determine that the person of interest is likely to want to see items that match with a previous purchase (e.g., shirts, shoes, slacks, etc., which match with a recently purchased sport coat).

In some cases, output from the inference engine may not be immediately displayed. Instead, such information may be pre-fetched and locally cached, e.g., for potential later display. This may be useful when the person of interest has contacted a stylist to set up an appointment with a particular purchase in mind. For instance, if the person of interest is about to be a groom, it would be common for that person to request a consultation for a tuxedo. The stylist may program or otherwise control the system to present displays oriented towards helping the client make purchases relevant to this event. In this sense, a stylist may override output from an inference engine, e.g., when an appointment is made, based on the stylist's expertise or pre-existing relationship with the person of interest, etc.

Regardless of whether output from the inference engine is displayed immediately or over time, it will be appreciated that a customized display is generated and at some point output in certain example instances. The customized display in turn provides an immersive experience with a level of customization detail based on the identified attribute(s) of the person of interest, which is more likely to be more detailed or greater in number for at least some recognized persons of interest. It will be appreciated that the level of customization detail associated with the customized display output may vary based on a number, type, and/or confidence of the identified attribute(s), whether the client has a user profile that can be identified, etc. In general, a finer-grained level of customization detail may be provided for identified clients and/or clients having user profiles, compared to unidentified persons or interests. Despite different levels of customization, the same or similar levels of immersion may be provided. That is, by gleaning at least a threshold amount of information about the person, the displays can be initially set up and then updated over time based on user movements and/or interactions with items in the location. In this way, the strength of the recommendations and/or level of confidence that the displays will be of interest to the person is likely to increase overtime, even for potentially unknown potential clients.

The system monitors for new information streaming into the system. See step S710 in this regard. Broadly speaking, surveillance information may be provided to the inference engine based on surveillance of the person of interest as the person of interest moves about and/or interacts with items in the location. For example, the surveillance may make use of data identifying a current area out of a plurality of predefined areas in the location that the person of interest presently is in. A tracking module may facilitate such operations using input from the camera(s) and/or proximity sensor(s).

Further information may be gleaned from the client interacting with physical items in the store. The surveillance information in this sense may include data indicative of physical interactions with items in the current area. This may include, for example, the client casually touching a fabric, trying on a blazer or pulling an item off of a rack and closely inspecting it, quickly walking by a display of some sort, etc. Cameras and/or proximity sensors may be used to gather information about the movements of a person, e.g., within one of a plurality of predefined zones within a location, proximate to one of a plurality of pre-identified display areas, etc.

The camera(s) also may be used to obtain information usable to infer emotional states. This may include, for example, watching for facial expressions, changes in facial coloration, posture, etc. Surveillance information those may power inferences based on emotional states or the like. Emotional inference systems are known. Their techniques can be augmented by taking into account the range of emotions and body movements that might be expected to be encountered with shopping. Moreover, when specific potential clients are recognized by the surveillance, user-specific information can be referenced to improve the accuracy of the emotional inferences.

Another way that information can be gleaned is from a stylist or the client providing information using a handheld device 114 of the type described above. For example, a stylist may take notes about what the client is doing and/or saying, modulated potentially by the stylist's expertise and any discrepancies between what is being said (e.g., “I like pleated pants”) to what is being done (e.g., only flat-front chinos being picked-up and/or tried-on), etc. Information regarding physical interactions of both the person of interest and the stylist of other authorized personnel at the location may be monitored. This information may be provided to the inference engine, but it may be weighted differently. For example, recommendations from the stylist may be weighted less heavily than selections made by the potential client in the first instance, selections made by the stylist may be weighted more heavily if they are lingered upon longer than selections made by the potential client, etc.

The surveillance information, however gathered, may be gathered and potentially provided to the inference engine substantially in real-time, e.g., as the person of interest is in the location.

If a sufficient amount of new information is received, data may be provided to the inference engine for new output to be developed and displays to be updated, e.g., as indicated in step S712. In certain example embodiments, data may be automatically transmitted as it is received or processed, in batch every predefined time interval (e.g., once per 30 seconds or minute), upon a triggering event (e.g., an input from a stylist), and/or the like. Surveillance information may be stored locally until it is ready for transmission to the inference engine, in the event that the inference engine is off-site (e.g., in the cloud or other network location). Thus, the level of customization detail may become more fine-grained for a given unidentified person of interest as the given unidentified person of interest continues to move about in the location.

In some cases, the stylist or the user may control the displays, e.g., to pause a moving video or rotating set of images, to zoom-in or zoom-out on a detail (e.g., to view stitching or a fine herringbone pattern), to select or apply a customization to a garment (e.g., select a stitching color, to specify a fabric type or fabric collection, to specify a center vent for a jacket, to apply a pattern to a tie, to indicate a desire for functional buttons on jacket sleeves, etc.), etc. In certain example embodiments, the display devices may be updatable to include visual representations of items being interacted with and/or other items associated with items being interacted with (e.g., to simulate selections, or the like), items in the current area and/or other items associated within the current area, etc.

In certain example embodiments, information about the person's session in the location may be stored locally and/or used to update (and potentially even create) an associated user profile. For example, if the potential client is a first-time user of the system, a new user profile could be constructed based on information provided during a pre-survey or pre-meeting consultation, as well as information gathered while the surveillance is taking place (e.g., based on items interacted with, information provided by a stylist, etc.) and any completed translations.

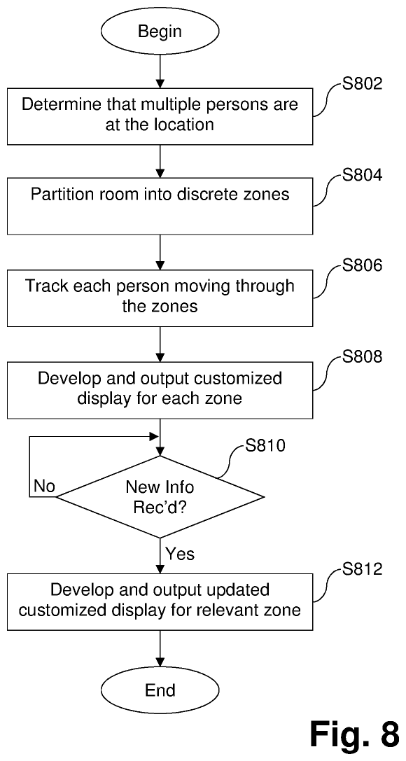

Sometimes, multiple potential clients will be present in a showroom at a given time. The system's operation may be controlled to account for this possibility. In this regard, FIG. 8 is a flowchart showing an example process for operating a digital display system when there are multiple potential clients in a location, in accordance with certain example embodiments. In step S802, a determination is made that multiple persons of interest are at the location. This determination may be in connection with the camera(s) and using facial recognition or other techniques to distinguish between persons of interest (and potentially between those persons and stylists/employees). The room is partitioned into discrete zones in step S804. These zones may map to places where the display areas are located, different predefined segments of the store (e.g., discrete evenly distributed blocks of space), etc. Tracking techniques may use camera and/or proximity sensor data to track each person as each person moves through the various zones.

Similar to the above, a customized display may be generated; however, as indicated in step S808, the output may be developed on a zone-by-zone basis for each zone having a display array. The display may be customized for the person in or closet to the particular zone in which the display array is located. If there are multiple persons in a single zone, a first set of conflict resolution rules may be applied. Such conflict resolution rules may indicate that displays should be split evenly, that preference should be given to recognized clients over non-recognized potential clients, that recognized clients who have spent more or have higher spend potential should receive preferential display, etc.

Similarly, if multiple persons are equidistant from a display, a second set of conflict resolution rules may be applied. Such conflict resolution rules may use the same or other rules. Alternatively, or in addition, the rules may specify that displays should be tailored based on moving direction and/or orientation of a person. Thus, even though a person may be closer to a given display array, if the person is facing or walking away from it, then that display array may not need to be considered for conflict resolution because it is not within that person's field of view and likely interaction range. In certain example embodiments, different levels of display device selections may be provided. In a first level, those display devices closest to a given potential client may be designated for that potential client. In a second level, the direction in which that potential client is facing may be taken into account. For instance, face tracking, eye tracking, gesture recognition, and/or other techniques may further down-select a number of displays relevant for the potential clients. In this way, a display closer to a first client than a second client nonetheless may display information relevant for the second client because the second client is facing it while the first client is facing away. Other layers or levels of customization may be applied.

As above, new information is received in step S810. And as above, updated customized displays are developed and output for relevant zones in step S812.

When an individual is identified (e.g., when a QR code is scanned), product pairings, instructions, and outfit ideas additionally or alternatively can be provided via a display array. Functionality disclosed in U.S. Application Ser. No. 62/860,846 filed on Jun. 13, 2019 and in U.S. Publication No. 2020/0394699 can be used in a physical setting, e.g., based on interaction with the device 114 as controlled by the person of interest and/or an authorized user. The entire contents of U.S. Application Ser. No. 62/860,846 and U.S. Publication No. 2020/0394699 are hereby incorporated by reference herein.

As indicated above, a potential client may engage with and take control over some or all of the display arrays in a location in certain example embodiments. In certain example embodiments, one or more display devices may display a QR code or other link information. Link information may be embedded in a QR code or may be provided in a human-readable format. It may include a URL address that can be typed into a browser, recognized via an OCR technique, or the like. In some instances, a code that can be manually entered into a standalone app running on a smart device (e.g., a smartphone or tablet), web application, or the like, may be used. The link information enables the device that uses it to assume control of the style wall. For example, scanning a QR code or the like may open a web browser, start a web application, and/or the like.

Once the link information is entered, the device is authenticated and control is provided if certain conditions are met. These conditions may include, for example, ensuring that no one else already has control of the display arrays, ensuring that the attempted access is permitted by the location, confirming that the timeframe for control is granted, etc.

In this regard, the control may be granted for in-store control during normal open hours of the location, for “after-hours” store control, or at any time specifically indicated by and in accordance with conditions specifiable by authorized personnel at the location. The number and types of display arrays available for controlled may be specified by the location. For example, a location may decide to limit itself to allowing only in-window displays to be controlled during the day but may decide that all displays can be controlled after-hours. In certain example embodiments, the location might provide a locking instruction that prevents control during appointments, certain times of day or night (e.g., to comply with local ordinances), etc.

In certain example embodiments, control may be provided to enable to a potential client to browse or customize items, build wardrobes, see specials or advertisements, review suggestions developed for them specifically (e.g., using suggestions built by the inference engine using the techniques described above, as aided by potential unique user recognition via identification of the device and/or the access credentials being used), etc.

Information about items accessed, displays controlled, when and for what period of time the control was taken, ensembles built, etc., may be tracked and stored on an individual and aggregate basis. Individual basis storage may be facilitated using unique identifiers of or on the mobile device (e.g., a telephone number, mobile equipment identifier (MEID), cookie placed on the device, etc.), login credentials, etc. The individual and aggregate information can be used to develop a feel for local trends, what is popular and what could be promoted, etc.

It will be appreciated that as used herein, the terms system, subsystem, service, engine, module, programmed logic circuitry, and the like may be implemented as any suitable combination of software, hardware, firmware, and/or the like. It also will be appreciated that the storage locations, stores, and repositories discussed herein may be any suitable combination of disk drive devices, memory locations, solid state drives, CD-ROMs, DVDs, tape backups, storage area network (SAN) systems, and/or any other appropriate tangible non-transitory computer readable storage medium. Cloud and/or distributed storage (e.g., using file sharing means), for instance, also may be used in certain example embodiments. It also will be appreciated that the techniques described herein may be accomplished by having at least one processor execute instructions that may be tangibly stored on a non-transitory computer readable storage medium.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of controlling a digital display and surveillance system comprising a plurality of display devices provided in a location, a computing system having a data store and processing resources including at least one processor and a memory coupled thereto, and at least one camera in the location, the method comprising:
responsive to a determination that a person of interest has entered the location,
identifying one or more attributes of the person of interest;
developing a customized display to be output for the display devices, the customized display being developed by an inference engine running on the computing system in connection with the processing resources, wherein the customized display provides an immersive experience with a level of customization detail based on the identified attribute(s) of the person of interest;
controlling the display devices to output the customized display;
providing surveillance information to the inference engine based on surveillance of the person of interest as the person of interest moves about, and/or interacts with items, in the location, the surveillance information including data identifying a current area out of a plurality of predefined areas in the location that the person of interest presently is in;
developing updates to the customized display responsive to surveillance information being successively provided to the inference engine; and
controlling the display devices to output the update.

2. The method of claim 1, wherein the surveillance information includes data indicative of physical interactions with items in the current area.

3. The method of claim 1, further comprising inferring emotional information of the person of interest based on the surveillance information, the inferred emotional information being providable to the inference engine.

4. The method of claim 1, further comprising providing to the inference engine input from an authorized user tracking the person of interest, the authorized user being different from the person of interest.

5. The method of claim 4, wherein the input from the authorized user is provided via a registered electronic device, substantially in real-time, as the person of interest is in the location.

6. The method of claim 4, wherein the surveillance information includes information regarding physical interactions of both the person of interest and the authorized user, that information regarding physical interactions being differently weighted by the inference engine based on whether the physical interactions are undertaken by the person of interest, the authorized user, or both the person of interest and the authorized user.

7. The method of claim 1, further comprising providing to the inference engine input from the person of interest via a registered electronic device being used by the person of interest.

8. (canceled)

9. The method of claim 1, wherein the one or more attribute(s) include information about clothing and/or style of the person of interest.

10. The method of claim 1, wherein the one or more attributes enable the person of interest to be identified as being a pre-registered user having a user profile.

11. The method of claim 10, wherein the user profile includes information concerning garments and garment-related preferences of the pre-registered user.

12. The method of claim 10, wherein the inference engine processes data associated with the user profile.

13. The method of claim 10, wherein the person of interested is recognized as being a pre-registered user by scanning a QR code provided by the person of interest, the QR code being displayable on a device belonging to the person of interest or being attached to or otherwise incorporated in clothing of the person of interest.

14. The method of claim 1, wherein the level of customization detail varies based on a number, type, and/or confidence of the identified attribute(s).

15. The method of claim 1, wherein a finer-grained level of customization detail is provided for identified pre-registered users compared to unidentified persons or interests.

16. The method of claim 1, further comprising storing to the data store information about the person of interest's session in the location, such session information including data about any, physical item interactions, physical or device-mediated selections, and/or data received from a device operated by an authorized user.

17. The method of claim 1, wherein the level of customization detail becomes more fine-grained for a given unidentified person of interest as the given unidentified person of interest continues to move about in the location.

18. The method of claim 1, wherein the display devices are updatable to include visual representations of items being interacted with and/or other items associated with items being interacted with.

19. The method of claim 1, wherein the display devices are updatable to include visual representations of items in the current area and/or other items associated within the current area.

20. A digital display and surveillance system, comprising:
a plurality of display devices provided in a location;
a computing system having a data store and processing resources including at least one processor and a memory coupled thereto; and
at least one camera in the location;
wherein the computing system is configured to perform operations comprising, responsive to a determination that a person of interest has entered the location,
identifying one or more attributes of the person of interest;
developing a customized display to be output for the display devices, the customized display being developed by an inference engine running on the computing system in connection with the processing resources, wherein the customized display provides an immersive experience with a level of customization detail based on the identified attribute(s) of the person of interest;
controlling the display devices to output the customized display;
providing surveillance information to the inference engine based on surveillance of the person of interest as the person of interest moves about, and/or interacts with items, in the location, the surveillance information including data identifying a current area out of a plurality of predefined areas in the location that the person of interest presently is in;
developing updates to the customized display responsive to surveillance information being successively provided to the inference engine; and
controlling the display devices to output the update.

21.-23. (canceled)

24. A non-transitory computer readable storage medium storing instructions that, when executed, perform operations corresponding to the method of claim 1.
